(19) United States
(12) Patent Application Publication
(10) Pub. No.: US 2001/0017162 A1
(43) Pub. Date: Aug. 30, 2001

(54) Valve device for hermetic reciprocating compressor

(76) Inventor: Seung-Don Seo, Kwangiu-City (KR)

Correspondence Address: Charles F. Wieland III, BURNS, DOANE, SWECKER & MATHIS, L.L.P., P.O. Box 1404, Alexandria, VA, 22313-1404, US

(21) Appl. No.: 09/791,564

(22) Filed: Feb. 26, 2001

(30) Foreign Application Priority Data
Feb. 26, 2000 (KR) 009676/2000

(51) Int. Cl. F16K 15/16; F04B 39/10

(52) U.S. Cl. 137/855; 417/571

(57) ABSTRACT

Disclosed is a valve device for a hermetic reciprocating compressor, more particularly, a valve device for a hermetic reciprocating compressor in which a seat portion of a valve plate, an intake portion and a discharge passport have an area for restraining a resonance sound and an impacting sound. The valve device of a hermetic reciprocating compressor in which an outlet valve and an keeper are fixed to one side of a valve plate, and an intake valve is coupled to a cylinder block to be closely contacted with the other side of the valve plate, is characterized in that the valve plate has an intake port which is opened/closed by a driving of the intake valve and has a diameter of 5.0-6.0 mm, a seat portion to which the intake valve is closely contacted and an external diameter of 6.2-7.2 mm, and an exhausting pass port which has a diameter of 3.5-4.5 mm.

### BACKGROUND OF THE INVENTION

1. Field of the Invention

The present invention relates to a valve device for a hermetic reciprocating compressor, more particularly, a valve device for a hermetic reciprocating compressor in which a seat portion of a valve plate, an intake portion and a discharge pass port have an area for restraining a resonance sound and an impacting sound.

2. Description of the Related Art

Generally, a compressor compresses a gas in a state of a low temperature and low pressure to change into a high temperature and high pressure gas. In this specification, a hermetic compressor, in which a piston is reciprocated, will be described.

The hermetic reciprocating compressor includes a main body which forms an external appearance of the compressor so as to maintain a gas tight therein, a stator which is fixed in the main body, a crank shaft which is mounted to be rotated by a magnetic field formed by a rotor, a piston one end of which is connected to the crank shaft to be reciprocated in a block, and a valve device through which a refrigerant compressed by the piston is discharged to an outlet pipe.

Here, a valve device of a conventional hermetic reciprocating compressor will be described referring to FIGS. 1 to 3 which show a valve device of a hermetic reciprocating compressor according to the present invention. The valve device of the conventional hermetic reciprocating compressor includes an intake valve 12, a valve plate 13 which is formed with an intake port 13a opened/closed by the intake valve 12, an exhausting valve 14 for opening/closing an outlet port 13b formed in the valve plate 13, a keeper 15 for limiting an opening/closing area of the valve plate to keep a regular position thereof. The intake valve 12, the valve plate 13, the outlet valve 14 and the keeper 15 are fixed to an upper portion of a cylinder block 9 by a rivet 16 in order.

The intake port 13a and a valve 12c of the intake valve 12 are closely contacted to a seat portion P of the valve plate. Based on a technical theory, the intake port 13a has a diameter of 6.5 mm. The seat portion P of the valve plate has an internal diameter C of 7.9 mm and an external diameter D of 10 mm. An exhausting pass port 13e formed on the valve plate 13 has a diameter of 6.5 mm.

A reference B in FIG. 3 indicates a diameter of the intake port 13a.

In the conventional hermetic reciprocating compressor, when a crank shaft 6 is rotated, a piston 10 is reciprocated within a cylinder. Thus, the refrigerant is sucked, compressed and exhausted in accordance with the reciprocating of the piston 10. The refrigerant introduced through an intake pipe 8 is moved through an intake muffler 8a to an intake chamber 11a of a cylinder head 11. Sequentially, the refrigerant is introduced through the intake port 13a of the valve plate 13 into the cylinder, and then compressed by the piston 10.

The refrigerant compressed in the cylinder opens the exhausting valve 14 through the outlet port 13b of the valve plate 13 and is discharged through an outlet chamber 11b of the cylinder head 11 and an exhausting pipe(not shown) to an outside of an upper case 1 and a lower case 2.

However, according to a substantial experiment of a resonance sound showing relationship between the intake port 13b and the intake valve 12, there is a problem that the intake port 13a has too large diameter of 6, 5 mm, since a modulating sound is generated.

In addition, as a result of measuring a performance and a noise of the exhausting pass port 13e, there is a problem that the exhausting pass port 13e also has too large diameter of 6.5 mm which is the same as that of the intake port 13a.

Further, since the seat portion P also has too large size, there is problem that an impacting sound is generated and a peak in a high-frequency band is also generated due to an increasing of pressure by an increasing of viscous resistance.

### SUMMARY OF THE INVENTION

It is therefore an object of the present invention to provide a hermetic reciprocating compressor in which a movement of the valve is optimized when sucking and discharging the refrigerant, and the resonance sound and the impacting sound is restrained between the seat portion of valve plate and the valve.

To achieve the above objects and other advantages, there is provided a valve device of a hermetic reciprocating compressor in which an outlet valve and an keeper are fixed to one side of a valve plate, and an intake valve is coupled to a cylinder block to be closely contacted with the other side of the valve plate, characterized in that the valve plate has an intake port which is opened/closed by a driving of the intake valve and has a diameter of 5.0-6.0 mm, a seat portion to which the intake valve is closely contacted and an external diameter of 6.2-7.2 mm, and an exhausting pass port which has a diameter of 3.5-4.5 mm.

Preferably, the intake port has a diameter of 5.5 mm, the seat portion has an internal diameter of 6.7 mm and an external diameter of 10 mm, and the exhausting pass port has a diameter of 4.0 mm.

### BRIEF DESCRIPTION OF THE DRAWINGS

The above object and other advantages of the present invention will become more apparent by describing in detail the preferred embodiments thereof with reference to the accompanying drawings, in which:

FIG. 1 is a schematic cross-sectional view of a compressor according to the present invention;

FIG. 2 is an exploded perspective view of a valve device showing a state that a valve plate is mounted according to the present invention; and

FIG. 3 is a cross-sectional view taken along a line A-A of FIG. 2.

### DETAILED DESCRIPTION OF THE PREFERRED EMBODIMENTS

The present invention now will be described more fully hereinafter with reference to the accompanying drawings, in which preferred embodiments of the invention are shown.

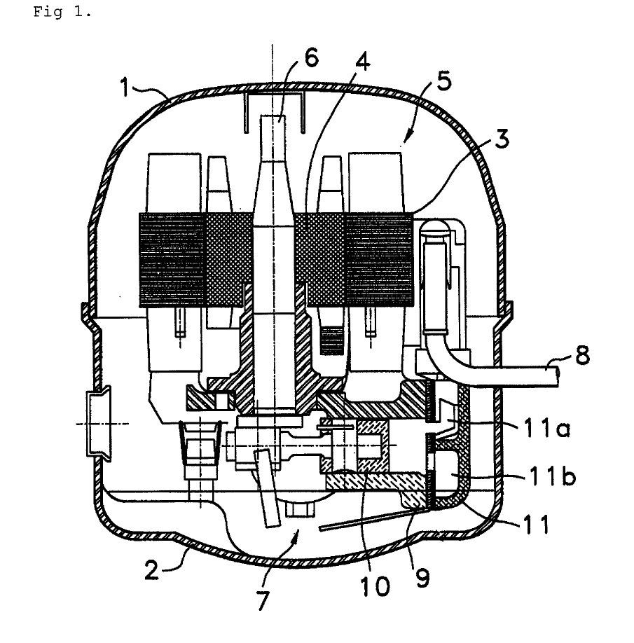

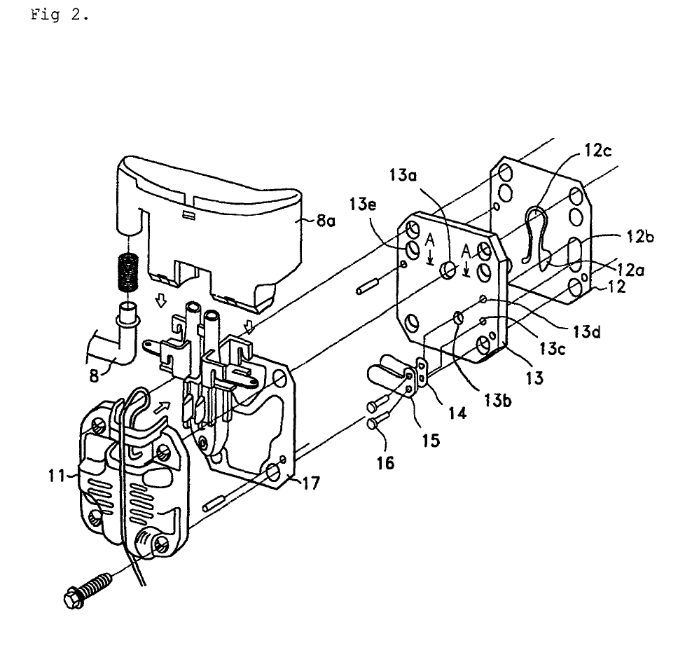

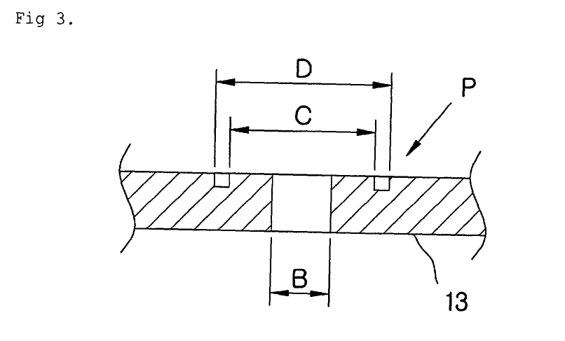

FIG. 1 is a schematic cross-sectional view of a compressor according to the present invention, FIG. 2 is an exploded perspective view of a valve device showing a state that a valve plate is mounted according to the present invention and FIG. 3 is a cross-sectional view taken along a line A-A of FIG. 2.

As shown in FIG. 1, a hermetic reciprocating compressor includes a driving part 5 which is formed with a stator 3 and a rotor 4 within an upper case portion 1 and a lower case portion 2, and a compressing portion 7 for sucking, compressing and then discharging a refrigerant by a rotating operation of a crankshaft 6 fixed to a center of the rotor 4.

The compressing portion 7 is comprised of a cylinder block 9 for providing a compressing space of the refrigerant introduced through a intake pipe 8, a piston 10 which is disposed in an inside of the cylinder block 9 to be reciprocated by a rotation of the crankshaft 6, a cylinder head 11 for opening/closing the cylinder block 9, and a valve device which is interposed between the cylinder block 9 and the cylinder head 11 to suck the refrigerant into the cylinder and simultaneously discharge the compressed refrigerant.

As shown in FIGS. 1 and 2, The valve device of the conventional hermetic reciprocating compressor includes an intake valve 12, a valve plate 13 which is formed with an intake port 13a opened/closed by the intake valve 12, an exhausting valve 14 for opening/closing an outlet port 13b formed in the valve plate 13, a keeper 15 for limiting an opening/closing area of the valve plate to keep a regular position thereof. The intake valve 12, the valve plate 13, the outlet valve 14 and the keeper 15 are fixed to an upper portion of a cylinder block 9 by a rivet 16 in order.

Further, a cylinder head gasket 17 is disposed between the cylinder head 11 and the valve device to prevent a leakage of the refrigerant.

Meanwhile, in a seat portion P, with which the intake port 13a and valve 13c of the intake valve 12 are closed contacted, as shown in FIG. 3, a resonance sound showing a relationship between the intake valve 12 and the intake port 13a was hardly generated in a diameter of 5.0-6.0 mm, and was the smallest at a diameter of 5.5 mm.

At this time, according to an experiment of measuring an efficiency and a noise of an exhausting pass port 13e in a state of setting the diameter of the intake port 13a at 5.5 mm, the noise was hardly generated in a diameter of 3.5-4.5 mm and was the smallest at a diameter of 4.0 mm.

When an internal diameter C of the seat portion P was 6.2-7.2 mm and an external diameter D was 9.5-10.5 mm, the impacting sound was not generated, and the viscous resistance and the pressure was not increased. Therefor, the peak was not generated at a high-frequency band.

A reference B is an intake port 13a, 12a indicates a hole which is communicated with the outlet port 13b, 12b is an escaping groove which is formed to prevent an interference when the rivet 16 is mounted, and 13c and 13d indicate holes through which the rivet 16 is inserted.

In the hermetic reciprocating compressor, as described above, when a crank shaft 6 is rotated, a piston 10 is reciprocated within a cylinder. Thus, the refrigerant is sucked, compressed and exhausted in accordance with the reciprocating of the piston 10. The refrigerant introduced through an intake pipe 8 is moved through an intake muffler 8a to an intake chamber 11a of a cylinder head 11. Sequentially, the refrigerant is introduced through the intake port 13a of the valve plate 13 into the cylinder, and then compressed by the piston 10.

The refrigerant compressed in the cylinder opens the exhausting valve 14 through the outlet port 13b of the valve plate 13 and is discharged through an outlet chamber 11b of the cylinder head 11 and an exhausting pipe(not shown) to an outside of an upper case 1 and a lower case 2.

At this time, the intake port 13a, the seat portion P and the exhausting pass port 13e are designed at an optimal condition so that the noise is reduced.

According to the valve device of the present invention, since the movement of the valve is optimized, the resonance sound and the impacting sound between the seat portion of the valve plate and the valve is minimized.

It will be apparent to those skilled in the art that various modifications and variations of the present invention can be made without departing from the spirit or scope of the invention. Thus, it is intended that the present invention cover the modifications and variations of this invention provided they come within the scope of the appended claims and their equivalents.

What is claimed is:

1. A valve device of a hermetic reciprocating compressor in which an outlet valve and an keeper are fixed to one side of a valve plate, and an intake valve is coupled to a cylinder block to be closely contacted with the other side of the valve plate, characterized in that:
the valve plate has an intake port which is opened/closed by a driving of the intake valve and has a diameter of 5.0-6.0 mm, a seat portion to which the intake valve is closely contacted and an external diameter of 6.2-7.2 mm, and an exhausting pass port which has a diameter of 3.5-4.5 mm.
